(19) United States
(12) Patent Application Publication
(10) Pub. No.: US 2011/0057534 A1
(43) Pub. Date: Mar. 10, 2011

(54) REVERSE ELECTROMOTIVE FORCE GENERATING MOTOR

(76) Inventor: Toshio GODA, Ibaraki (JP)

(21) Appl. No.: 12/556,129

(22) Filed: Sep. 9, 2009

(30) Foreign Application Priority Data
Sep. 4, 2009 (JP) 2009-204311

(51) Int. Cl. H02K 3/28

(52) U.S. Cl. 310/179

(57) ABSTRACT

A reverse electromotive force generating motor includes a stator yoke; a rotor disposed in the stator yoke; a first coil disposed in the stator yoke and connected to a first input line of a power source with a first phase; a second coil disposed in the stator yoke and connected to the first coil in series, the second coil being connected to a neutral point; a third coil disposed in the stator yoke and connected to the first input line; a fourth coil disposed in the stator yoke and connected to the third coil in series, the fourth coil being connected to a first output line for outputting power; and a rotational shaft disposed in the rotor.

### BACKGROUND OF THE INVENTION AND RELATED ART STATEMENT

The present invention relates to a reverse electromotive force generating motor having both a function of an engine motor and a function of an electric generator.

When one of a three-phase alternate current changes a polarity and a voltage thereof, the voltage becomes zero at one point. A reverse electromotive force is generated when the voltage becomes zero. When the reverse electromotive force is supplied from, for example, a motor to an inverter due to a short-circuit fault of the inverter, a cable connecting the motor and the inverter may be damaged.

Patent Reference has disclosed a motor having a short circuit fault detecting circuit in order to prevent the problem described above.
Patent Reference: Japanese Patent Publication No. 2007-181345

In the motor disclosed in Japanese Patent Application, the short circuit fault detecting circuit has to be provided in the motor. Consequently, a more complicated process is required for manufacturing the motor, thereby increasing manufacturing cost thereof.

In view of the problems described above, an object of the present invention is to provide a reverse electromotive force generating motor (a motor) with a rotor functioning as both a motor and an electric generator. The motor changes a direction of a reverse electromotive force generated at a fixed coil thereof before the reverse electromotive force reaches an inverter, thereby resolving the problems described above.

Further objects and advantages of the invention will be apparent from the following description of the invention.

### SUMMARY OF THE INVENTION

In order to attain the objects described above, according to the present invention, a reverse electromotive force generating motor includes a stator yoke; a rotor disposed in the stator yoke; a first coil disposed in the stator yoke and connected to a first input line of a power source with a first phase; a second coil disposed in the stator yoke and connected to the first coil in series, the second coil being connected to a neutral point; a third coil disposed in the stator yoke and connected to the first input line; a fourth coil disposed in the stator yoke and connected to the third coil in series, the fourth coil being connected to a first output line for outputting power; and a rotational shaft disposed in the rotor.

### BRIEF DESCRIPTION OF THE DRAWINGS

FIG. 1 is a sectional view showing a reverse electromotive force generating motor according to a first embodiment of the present invention;

FIG. 2 is a sectional view showing a stator yoke of the reverse electromotive force generating motor according to the first embodiment of the present invention;

FIG. 3 is a circuit diagram of the reverse electromotive force generating motor according to the first embodiment of the present invention; and

FIG. 4 is a circuit diagram of a reverse electromotive force generating motor according to a second embodiment of the present invention.

### DETAILED DESCRIPTION OF THE PREFERRED EMBODIMENTS

Hereunder, embodiments of the present invention will be explained with reference to the accompanying drawing.

### First Embodiment

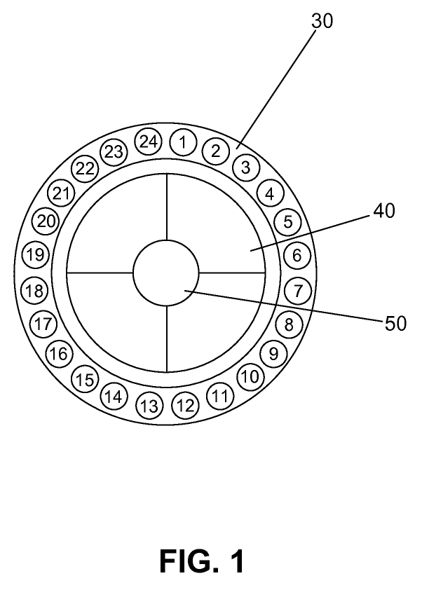

A first embodiment of the present invention will be explained. FIG. 1 is a sectional view showing a reverse electromotive force generating motor according to the first embodiment of the present invention.

As shown in FIG. 1, the reverse electromotive force generating motor includes a stator yoke 30; a rotor 40 disposed in the stator yoke 30; and a rotational shaft 50 disposed in the rotor 40.

As shown in FIG. 1, the stator yoke 30 has a plurality of slots 1 to 24 (twenty four slots in the embodiment) as hollow portions. A plurality of coils 101 to 103, 201 to 203, 301 to 303, and 401 to 403 (described later) is arranged in the slots 1 to 24 for generating an electromotive force around the stator yoke 30, so that the rotor 40 is attracted and rotates around the rotational shaft 50.

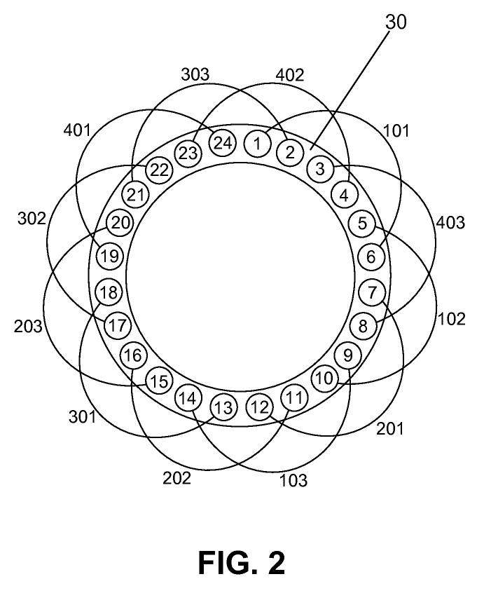

FIG. 2 is a sectional view showing the stator yoke 30 of the reverse electromotive force generating motor according to the embodiment of the present invention. The stator yoke 30 is a four-pole type, an arrangement of the coils 101 to 103, 201 to 203, 301 to 303, and 401 to 403 will be explained below.

As shown in FIG. 2, the stator yoke 30 is a four-pole type, and has twenty four slots for winding the coils 101 to 103, 201 to 203, 301 to 303, and 401 to 403. Alternatively, the stator yoke 30 may have forty eight slots. When a stator yoke is a six-pole type, the stator may have thirty six slots.

In the embodiment, the coils 101 to 103, 201 to 203, 301 to 303, and 401 to 403 are arranged in the slots 1 to 24 as follows. The coil 101 is disposed in the slots 1 and 6, and is connected to an input line of a first phase. The coil 301 is disposed in the slots 13 and 18, and is connected to the coil 101 in the input line of the first phase. The coil 201 is disposed in the slots 7 and 12, and is connected to an output line of the first phase. The coil 401 is disposed in the slots 19 and 24, and is connected to the coil 201 in the output line of the first phase.

In the embodiment, the coil 102 is disposed in the slots 5 and 10, and is connected to an input line of a second phase. The coil 302 is disposed in the slots 17 and 22, and is connected to the coil 102 in the input line of the second phase. The coil 202 is disposed in the slots 11 and 16, and is connected to an output line of the second phase. The coil 402 is disposed in the slots 23 and 4, and is connected to the coil 202 in the output line of the second phase.

In the embodiment, the coil 103 is disposed in the slots 9 and 14, and is connected to an input line of a third phase. The coil 303 is disposed in the slots 21 and 2, and is connected to the coil 103 in the input line of the third phase. The coil 203 is disposed in the slots 15 and 20, and is connected to an output line of the third phase. The coil 403 is disposed in the slots 3 and 8, and is connected to the coil 203 in the output line of the third phase.

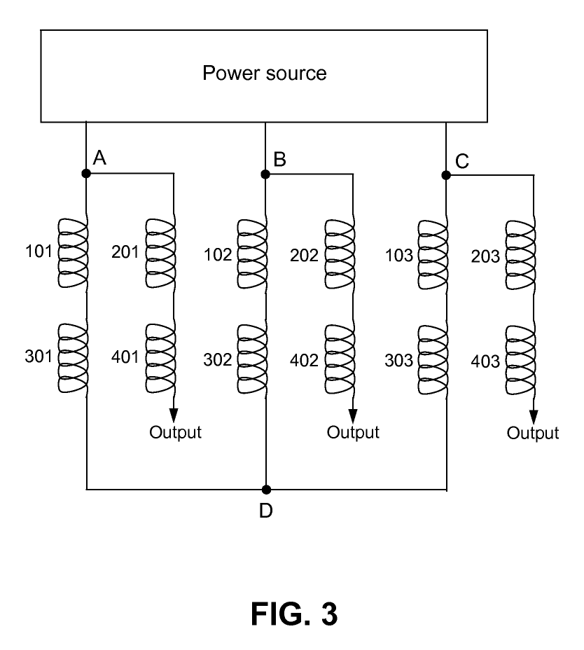

In the embodiment, the coils 101 to 103, 201 to 203, 301 to 303, and 401 to 403 are connected as follows. FIG. 3 is a circuit diagram of the reverse electromotive force generating motor according to the embodiment of the present invention.

As shown in FIG. 3, a power source has three input lines of three phases. The input line of the first phase is connected to the coil 101 at a connection point A, and the coil 101 is connected to the coil 301 in series. The input line of the second phase is connected to the coil 102 at a connection point B, and the coil 102 is connected to the coil 302 in series. The input line of the third phase is connected to the coil 103 at a connection point C, and the coil 103 is connected to the coil 303 in series. The coils 301, 302, and 303 are connected at a neutral point D.

Further, in the embodiment, three output lines are connected to the connection points A to C. The output line of the first phase is connected to the coil 201 at the connection point A, and the coil 201 is connected to the coil 401 in series. The output line of the second phase is connected to the coil 202 at the connection point B, and the coil 202 is connected to the coil 402 in series. The output line of the third phase is connected to the coil 203 at the connection point C, and the coil 203 is connected to the coil 403 in series.

An operation of the reverse electromotive force generating motor will be explained. In the following description, the first phase line of the reverse electromotive force generating motor of the four-pole type will be explained as an example. The second and the third phase lines rotate and generate electric power in the same way.

The motor reverse electromotive force generating rotates with a three-phase alternate current of 200 V. A magnetic field is generated at the coils 101, 201, 301, and 401 in the first phase line. The magnetic field thus generated attracts permanent magnets of the rotor 40, thereby rotating the rotor 40.

More specifically, the coil 101 and the coil 301 in the first phase line generate the magnetic field of an S pole in the stator yoke 30, and the coil 201 and the coil 401 in the first phase line generate the magnetic field of an N pole in the stator yoke 30.

When a voltage applied to the coil 101 and the coil 301 in the first phase line becomes zero, the coil 102 and the coli 302 in the second phase line generate the magnetic field of the S pole. Further, the coil 202 and the coli 402 in the second phase line generate the magnetic field of the N pole. Accordingly, the permanent magnets of the rotor 40 are attracted to the magnetic field, thereby rotating the rotor 40.

When the rotor 40 rotates as described above, a magnetic flux of the N pole traverses the coil 101 and the coil 301, thereby generating the reverse electromotive force. At the same time, a magnetic flux of the S pole traverses the coil 201 and the coil 401, thereby generating the electromotive force. At this moment, a reverse electromotive current flows toward the input line, and an electromotive current flows toward the output line.

In the embodiment, the coil 101 and the coil 201 are connected to the connection point A. Accordingly, the reverse electromotive current eventually flows toward the output line as an alternate current reverse current. As a result, it is possible to generate alternate current power.

### Second Embodiment

A second embodiment of the present invention will be explained next. In the second embodiment, the coils 101 to 103, 201 to 203, 301 to 303, and 401 to 403 are arranged in the slots 1 to 24 of the stator yoke 30 in the same way as that in the first embodiment.

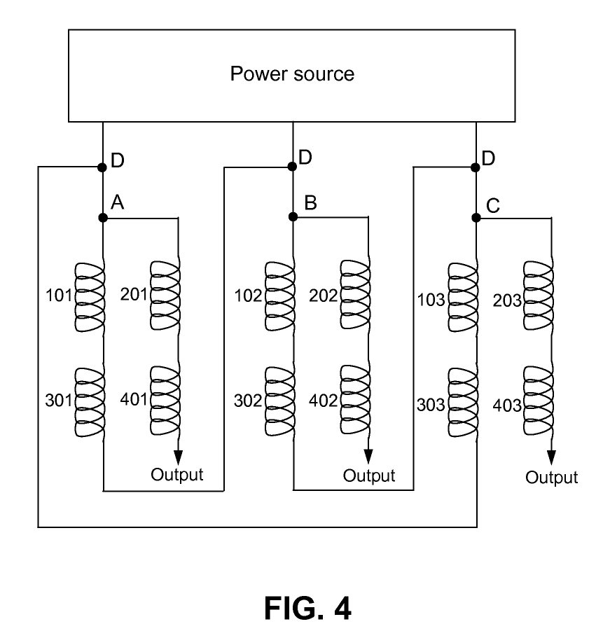

FIG. 4 is a circuit diagram of a reverse electromotive force generating motor according to the second embodiment of the present invention.

As shown in FIG. 4, a power source has three input lines of three phases. The input line of the first phase is connected to the coil 101 at a connection point A, and the coil 101 is connected to the coil 301 in series. The input line of the second phase is connected to the coil 102 at a connection point B, and the coil 102 is connected to the coil 302 in series. The input line of the third phase is connected to the coil 103 at a connection point C, and the coil 103 is connected to the coil 303 in series.

In the embodiment, the coil 301 is connected to the coil 102 at a neutral point D. Similarly, the coil 302 is connected to the coil 103 at a neutral point D, and the coil 303 is connected to the coil 101 at a neutral point D. In other words, in the embodiment, there are three neutral points D.

Further, in the embodiment, three output lines are connected to the connection points A to C. The output line of the first phase is connected to the coil 201 at the connection point A, and the coil 201 is connected to the coil 401 in series. The output line of the second phase is connected to the coil 202 at the connection point B, and the coil 202 is connected to the coil 402 in series. The output line of the third phase is connected to the coil 203 at the connection point C, and the coil 203 is connected to the coil 403 in series.

An operation of the reverse electromotive force generating motor in the second embodiment is similar to that in the first embodiment, and a detailed explanation thereof is omitted.

The disclosure of Japanese Patent Application No. 2009-204311, filed on Sep. 4, 2009 is incorporated in the application by reference.

While the invention has been explained with reference to the specific embodiments of the invention, the explanation is illustrative and the invention is limited only by the appended claims.

What is claimed is:

1. A reverse electromotive force generating motor, comprising:
a stator yoke;
a rotor disposed in the stator yoke;
a first coil disposed in the stator yoke and connected to a first input line of a power source with a first phase;
a second coil disposed in the stator yoke and connected to the first coil in series, said second coil being connected to a neutral point;
a third coil disposed in the stator yoke and connected to the first input line;
a fourth coil disposed in the stator yoke and connected to the third coil in series, said fourth coil being connected to a first output line for outputting power; and
a rotational shaft disposed in the rotor.

2. The reverse electromotive force generating motor according to claim 1, further comprising a fifth coil disposed in the stator yoke and connected to a second input line of the power source with a second phase; a sixth coil disposed in the stator yoke and connected to the fifth coil in series, said six coil being connected to the neutral point; a seventh coil disposed in the stator yoke and connected to the second input line; and an eighth coil disposed in the stator yoke and connected to the seventh coil in series, said eighth coil being connected to a second output line for outputting power.

3. The reverse electromotive force generating motor according to claim 1, further comprising a ninth coil disposed in the stator yoke and connected to a third input line of the power source with a third phase; a tenth coil disposed in the stator yoke and connected to the ninth coil in series, said tenth coil being connected to the neutral point; an eleventh coil disposed in the stator yoke and connected to the third input line; and a twelfth coil disposed in the stator yoke and connected to the eleventh coil in series, said twelfth coil being connected to a third output line for outputting power.

4. A reverse electromotive force generating motor, comprising:
a stator yoke;
a rotor disposed in the stator yoke;
a first coil disposed in the stator yoke and connected to a first input line of a power source with a first phase;
a second coil disposed in the stator yoke and connected to the first coil in series, said second coil being connected to a first neutral point;
a third coil disposed in the stator yoke and connected to the first input line;
a fourth coil disposed in the stator yoke and connected to the third coil in series, said fourth coil being connected to a first output line for outputting power; and
a rotational shaft disposed in the rotor.

5. The reverse electromotive force generating motor according to claim 4, further comprising a fifth coil disposed in the stator yoke and connected to a second input line of the power source with a second phase, said fifth coil being connected to the first neutral point; a sixth coil disposed in the stator yoke and connected to the fifth coil in series, said sixth coil being connected to a second neutral point; a seventh coil disposed in the stator yoke and connected to the second input line; and an eighth coil disposed in the stator yoke and connected to the seventh coil in series, said eighth coil being connected to a second output line for outputting power.

6. The reverse electromotive force generating motor according to claim 4, further comprising a ninth coil disposed in the stator yoke and connected to a third input line of the power source with a third phase, said ninth coil being connected to the second neutral point; a tenth coil disposed in the stator yoke and connected to the ninth coil in series, said tenth coil being connected to a third neutral point on the first input line; an eleventh coil disposed in the stator yoke and connected to the third input line; and a twelfth coil disposed in the stator yoke and connected to the eleventh coil in series, said twelfth coil being connected to a third output line for outputting power.

7. The reverse electromotive force generating motor according to claim 1, wherein said rotor includes a permanent magnet.

8. The reverse electromotive force generating motor according to claim 4, wherein said rotor includes a permanent magnet.

9. The reverse electromotive force generating motor according to claim 1, wherein said rotor includes an iron core.

10. The reverse electromotive force generating motor according to claim 4, wherein said rotor includes an iron core.
